(19) United States
(12) Patent Application Publication
(10) Pub. No.: US 2025/0115144 A1
(43) Pub. Date: Apr. 10, 2025

(54) VEHICULAR LOW PROFILE CHARGE PORT DOOR

(71) Applicant: Magna Mirrors of America, Inc., Holland, MI (US)

(72) Inventor: Kenneth C. Peterson, Ada, MI (US)

(21) Appl. No.: 18/906,366

(22) Filed: Oct. 4, 2024

Related U.S. Application Data
(60) Provisional application No. 63/588,807, filed on Oct. 9, 2023.

(51) Int. Cl. B60L 53/16; H01R 13/453

(52) U.S. Cl. CPC B60L 53/16; H01R 13/4534

(57) ABSTRACT

A vehicular charge port closure system includes a cover panel disposed at a charge port of a vehicle. The cover panel is movable between a closed position and an opened position. When an actuator is electrically operated to move the cover panel between the closed position and the opened position, the actuator imparts translational movement of a translating element relative to the charge port and an outer panel of the vehicle. The cover panel is pivotally mounted at the translating element. When the actuator is operated to move the cover panel from the closed position to the opened position, the translating element moves relative to the charge port and outer panel and the cover panel moves at least partially away from the outer panel of the vehicle and toward the charge port and moves at least partially behind the outer panel of the vehicle and away from the charge port.

### CROSS REFERENCE TO RELATED APPLICATION

The present application claims the filing benefits of U.S. provisional application Ser. No. 63/588,807, filed Oct. 9, 2023, which is hereby incorporated herein by reference in its entirety.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY OF THE INVENTION

A vehicular charge port closure system for a charge port cover panel includes a cover panel disposed at a vehicle equipped with the vehicular charge port closure system. The cover panel is movable between (i) a closed position, where the cover panel conceals a charge port of the vehicle, and (ii) an opened position, where the cover panel is moved away from the charge port relative to an outer panel of the vehicle to allow access to a charging connector of the charge port. An actuator is electrically operable to move the cover panel between the closed position and the opened position. When the actuator is electrically operated to move the cover panel between the closed position and the opened position, the actuator imparts movement of a shuttle or a translating element relative to the charge port and the outer panel of the vehicle. The cover panel is pivotally mounted at the translating element and the cover panel is moved between the closed position and the opened position according to translational movement of the translating element relative to the charge port and the outer panel of the vehicle. When the cover panel is moved from the closed position toward the opened position, the cover panel moves at least partially away from the outer panel of the vehicle and toward the charge port and moves at least partially behind the outer panel of the vehicle and away from the charge port. When the cover panel is moved from the opened position toward the closed position, the cover panel moves toward the charge port and moves at least partially toward the outer panel of the vehicle and away from the charge port. The cover panel may be movable along or within a first path of a track between the closed position and the opened position, and the translating element may be movable along or within a second path of the track to impart movement of the cover panel between the closed position and the opened position.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular electric charging system;

FIG. 2 is a perspective view of the charge port at the vehicle, with a cover panel of the charge port in the closed position;

FIG. 3 is a perspective view of the charge port at the vehicle, with the cover panel in the opened position to reveal a charging connector;

FIG. 4 is a perspective view of the charge port at the vehicle, with the cover panel in the opened position and a charging wand connected to the charging connector;

FIG. 5 is a rear perspective view of the charge port at the vehicle;

FIG. 6 is an exploded view of the charge port;

FIG. 7 is a perspective view of the cover panel movable along a lower guide element according to movement of a shuttle element along the lower guide element via rotation of a cam arm coupled to the shuttle element, with the cover panel in the closed position;

FIG. 8 is a perspective view of the cover panel of FIG. 7, with the cover panel moved along the lower guide element to the opened position;

FIG. 9 is a perspective view of the upper and lower guide elements of the charge port;

FIGS. 10 and 11 are perspective views of the actuator, actuator bracket, and shuttle element of the charge port;

FIG. 12 is a perspective view of the shuttle element of the charge port;

FIG. 13 is a perspective view of a cover panel bracket of the charge port; and

FIG. 14 is a perspective view of a pivotable linking element of the charge port.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

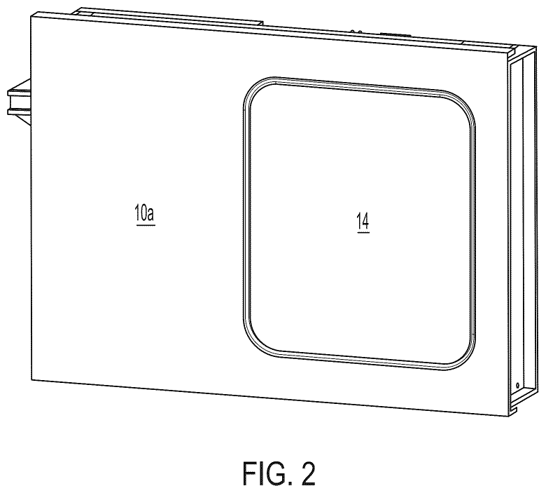

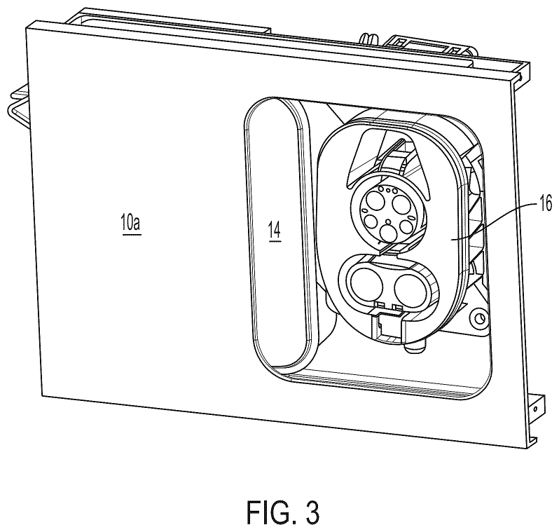

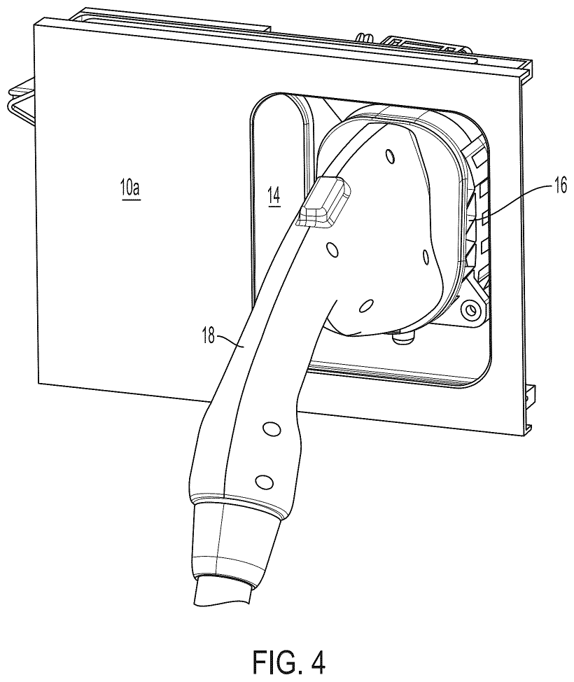

Referring now to the drawings and illustrative embodiments depicted therein, a vehicle 10 (e.g., an electric vehicle or EV, or a plug-in hybrid vehicle or PHEV) includes an electrical charging system or charge port 12 that may include a base portion or bracket and a cover panel or flap 14 (FIGS. 2-4). For example, the panel 14 is mounted at the vehicle or the base portion and has an outer surface that, when the panel 14 is in a closed position (FIG. 2), corresponds with and/or is substantially flush with an outer surface of the exterior panel(s) or body panels or outer panels 10a of the vehicle 10 at and around the charge port 12 of the vehicle. When in the closed position, the cover panel 14 conceals a charging connector 16 of the charge port 12 that is configured or operable to electrically connect with an electrical connector or charging wand 18 of a charging station or system to charge batteries of the vehicle 10. When in an open position (FIG. 3), the cover panel 14 moves relative to the base portion and at least partially away from the body panel 10a and behind the body panel 10a to reveal the charging connector such that the electrical connector of the charging wand (that is electrically connected to the charging station or system and that is configured or operable for electrically connecting to or plugging into the charging connector of the vehicle) can electrically connect to the charging connector (FIG. 4).

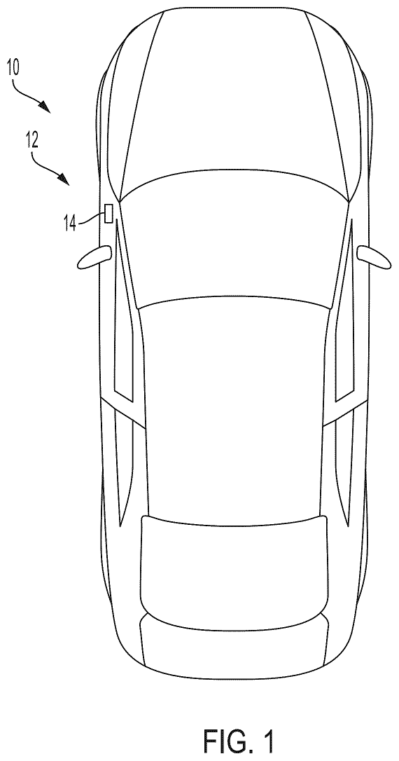

As shown in FIGS. 1 and 2, the charge port 12 is disposed along a side of the vehicle 10 and, when the cover panel 14 is in the closed position, the exterior surface of the panel 14 is substantially flush with and corresponds to the exterior surface of the outer panel 10a of the vehicle 10 and/or the base portion at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturers emblem, a portion of a headlight or taillight, a license plate bracket, or the like, where the closure system enables movement of the exterior feature between the closed and opened positions.

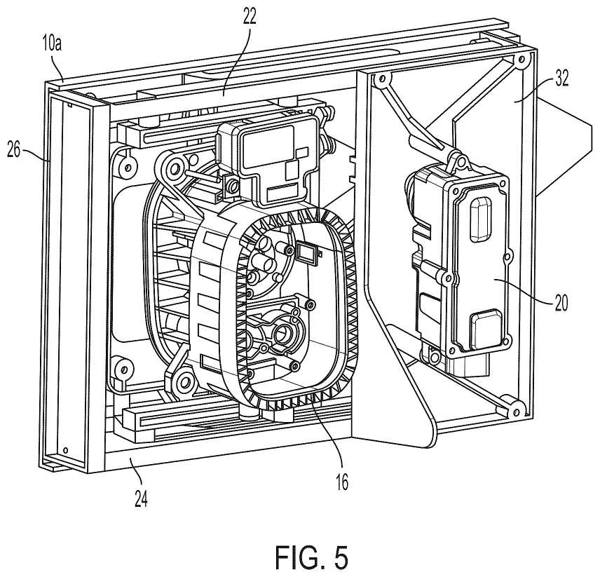

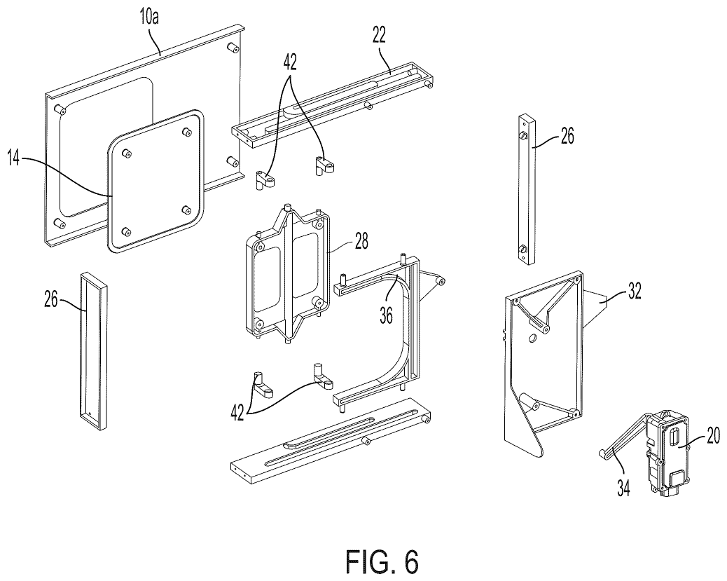

The cover panel 14 may be movable between the closed position and the opened position via operation of an electrically operable actuator 20 (FIGS. 5 and 6), which may be electrically operated to move the cover panel 14 in response to a user input. For example, the actuator 20 may deploy the cover panel 14 in response to a user input at a key fob associated with the vehicle, a button or sensor at the exterior surface of the charge port 12 or vehicle, or a button at the interior of the vehicle cabin. When actuated, the actuator 20 (such as an electrically operable motor of the actuator) operates to move the cover panel 14 from the closed position to the opened position, and the cover panel 14 may move relative to the base portion or vehicle in a sliding motion along the surface of the vehicle, such as along an interior surface of the body panel 10a or an outer surface of the body panel 10a. For example, the cover panel and actuator may utilize characteristics of the charge ports and charging systems described in U.S. Publication Nos. US-2024-0294077; US-2024-0246409; US-2024-0109409 and/or US-2023-0191926, and/or U.S. patent application Ser. No. 18/619,751, filed Mar. 28, 2024 (Attorney Docket DON10 P5089), and/or Ser. No. 18/644,212, filed Apr. 24, 2024 (Attorney Docket DON10 P5103), which are hereby incorporated herein by reference in their entireties.

The charge port 12 is configured to move the cover panel 14 in a sliding motion between the closed position and the opened position. For example, when moved from the closed position toward the opened position, the cover panel 14 moves at least partially inward toward the side of the vehicle and toward the charging connector 16 and away from the body panel 10a and at least partially along the body panel 10a within a cavity or interior portion of the vehicle behind the body panel 10a away from the charging connector 16. When moved from the opened position toward the closed position, the cover panel 14 moves out from behind the body panel 10a toward the charging connector 16 and away from the charging connector 16 toward the body panel 10a away from the side of the vehicle 10. Although described herein as moving along the side of the vehicle 10 in a direction parallel to a longitudinal axis of the vehicle (e.g., in a forward direction and a rearward direction), it should be understood that the cover panel 14 may move in any suitable direction relative to the outer panel 10a of the vehicle between the closed position and the opened position, such as in an upward direction and a downward direction or in angled or diagonal directions, or along a curved or non-linear path. Thus, the charge port 12 provides a low profile opening and closing movement to reduce or eliminate risk of impact between the cover panel 14 and objects exterior the vehicle 10, and to provide an aesthetically appealing opening and closing sequence.

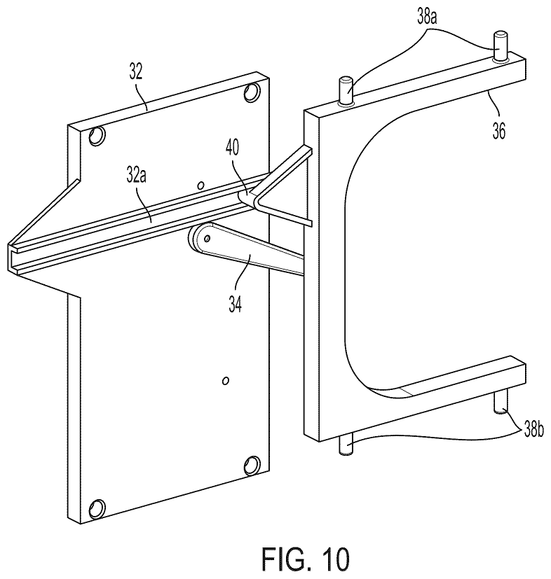

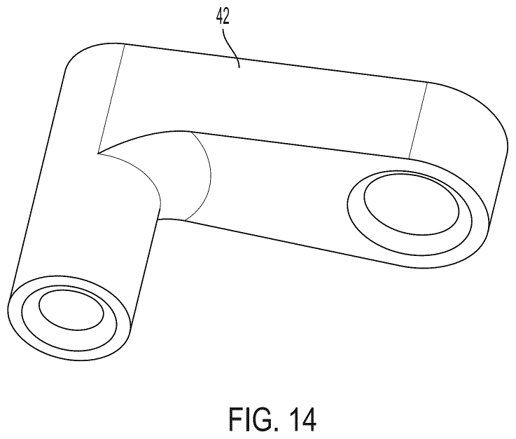

As shown in FIGS. 6-14, an upper guide member 22 and a lower guide member 24 are mounted at the vehicle 10 behind the body panel 10a, with the upper guide 22 extending along and/or above an upper edge of the aperture in the body panel 10a at which the cover panel 14 and charging connector 16 are disposed. The lower guide 24 extends substantially parallel to the upper guide 22 and along and/or below a lower edge of the aperture in the body panel 10a. Respective support members 26 may extend between the upper guide member 22 and the lower guide member 24 at opposing ends of the guide members, with the guide members and/or the support members 26 attaching at the inner surface of the body panel 10a, such as via threaded fasteners or other suitable attaching structure.

The cover panel 14 is mounted to a cover panel bracket 28, such as via an adhesive, threaded fasteners, or other suitable attaching structure. The cover panel bracket 28 includes an upper pin or guide 30a extending from an upper edge portion of the bracket 28 that is movably received along or within a cover panel guide slot 22a of the upper guide 22 and a lower pin or guide 30b extending from a lower edge portion of the bracket 28 that is movably received along or within a cover panel guide slot 24a of the lower guide 24. Thus, as the cover panel 14 and cover panel bracket 28 are moved between the closed position and the opened position, the upper pin 30a and the lower pin 30b of the bracket 28 move within the respective slots 22a, 24a of the upper guide 22 and the lower guide 24 and the slots 22a, 24a guide movement of the cover panel 14 relative to the body panel 10a between the closed position and the opened position. The upper guide element 22 and the lower guide element 24 cooperate to form a track guiding movement of the cover panel 14 between the closed position and the opened position.

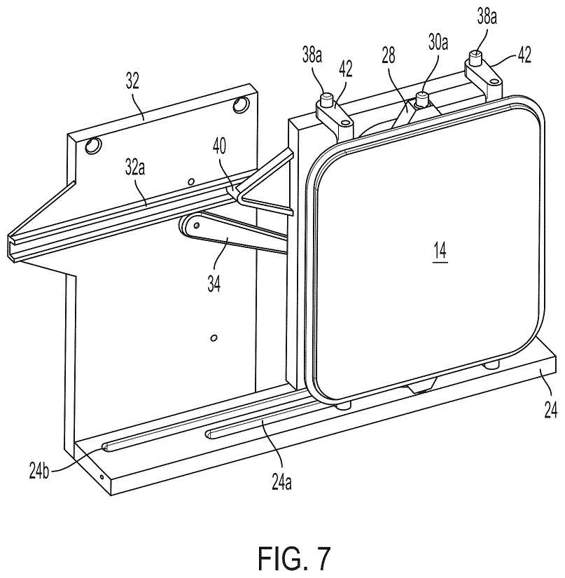

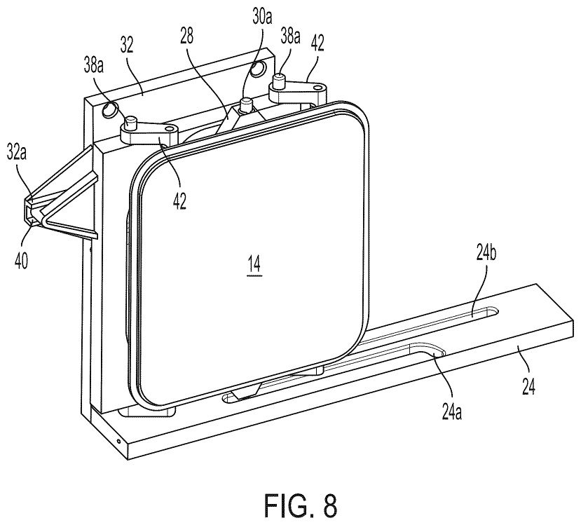

The actuator 20 is mounted at an actuator bracket 32 that may attach to the upper guide 22 and the lower guide 24 to fix the actuator 20 relative to the upper guide 22, the lower guide 24 and the body panel 10a (optionally, the actuator bracket may be otherwise fixed relative to the vehicle and the upper and lower guides). When the actuator 20 is electrically operated to move the cover panel 14 between the closed position and the opened position, the actuator 20 pivots a cam arm 34 relative to the actuator 20 and the actuator bracket 32. For example, the actuator 20 pivots the cam arm 34 along an arcuate path in a first direction (e.g., clockwise in FIG. 7) to move the cover panel 14 from the closed position (FIG. 7) toward the opened position (FIG. 8) and the actuator 20 pivots the cam arm 34 back along the arcuate path in an opposite second direction (e.g., counterclockwise in FIG. 7) to move the cover panel 14 from the opened position toward the closed position. The cam arm 34 is coupled to a shuttle element or translating element or transfer element or slider 36 that moves along or within the upper guide 22 and the lower guide 24 according to pivotal movement of the cam arm 34 relative to the actuator bracket 32.

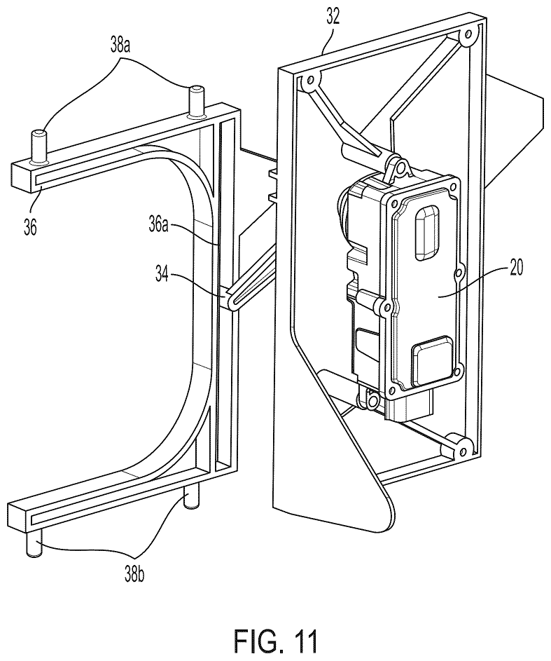

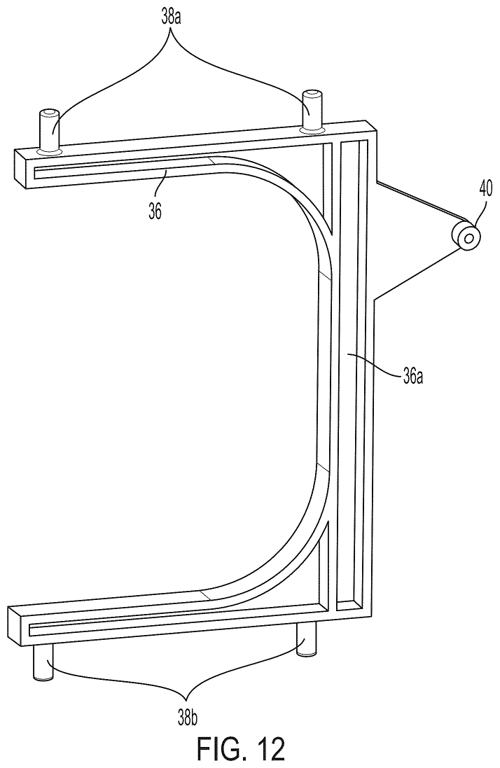

For example, and as shown in FIGS. 11 and 12, an end of the cam arm 34 is received along a vertically extending slot or channel or guide 36a of the shuttle element 36 so that, as the cam arm 34 pivots during operation of the actuator 20, the end of the cam arm 34 moves along the vertical slot 36a and the shuttle element 36 is moved laterally relative to the actuator bracket 32. The shuttle element 36 includes one or more upper pins 38a (such as two upper pins) that are movably received along or within a shuttle guide slot 22b of the upper guide 22 and one or more lower pins 38b (such as two lower pins) that are movably received along or within a shuttle guide slot 24b of the lower guide 24. Thus, as the shuttle element 36 moves relative to the actuator bracket 32, the upper pins 38a move within the upper shuttle guide slot 22b and the lower pins 38b move within the lower shuttle guide slot 24b to guide movement of the shuttle element 36. Further, a protrusion or pin 40 of the shuttle element 36 may be movably received along or within a channel or track 32a at the actuator bracket 32 to further constrain and/or guide movement of the shuttle 36 relative to the actuator bracket 32.

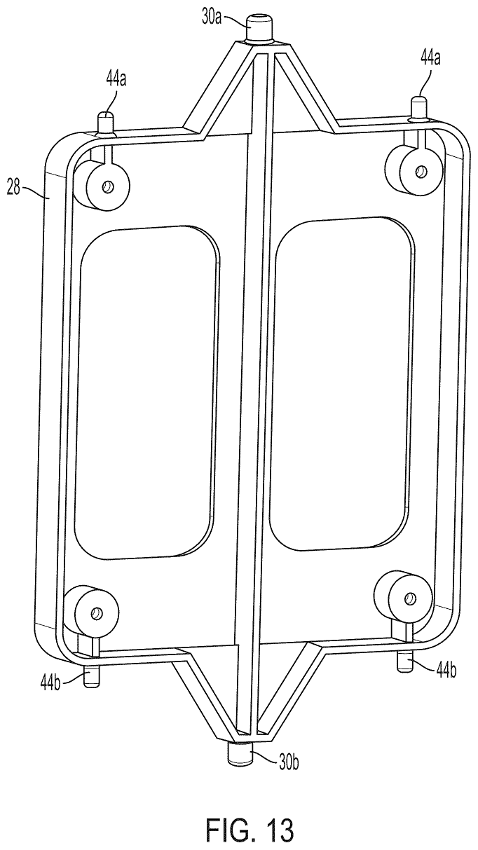

One or more links 42 extend between the shuttle element 36 and the door bracket 28 so that the cover panel bracket 28 and the cover panel 14 move between the closed position and the opened position according to movement of the shuttle element 36 within the upper guide element 22 and the lower guide element 24 (FIGS. 7, 8, and 14). For example, two upper links 42 and two lower links 42 attach between the shuttle element 36 and the cover panel bracket 28. Optionally, first ends of the links 42 are pivotally received at the respective upper pins 38a and the lower pins 38b of the shuttle element 36 and second ends of the links 42 are pivotally received at respective upper attachment pins 44a and lower attachment pins 44b at the cover panel bracket 28 (FIG. 13). Thus, when the actuator 20 is operated to pivot the cam arm 34, the cam arm 34 pivots relative to the actuator bracket 32 and the shuttle element 36 moves along or within the guide elements 22, 24 relative to the actuator bracket 32, with the cover panel 14 moving between the closed position and the opened position according to movement of the shuttle element 36.

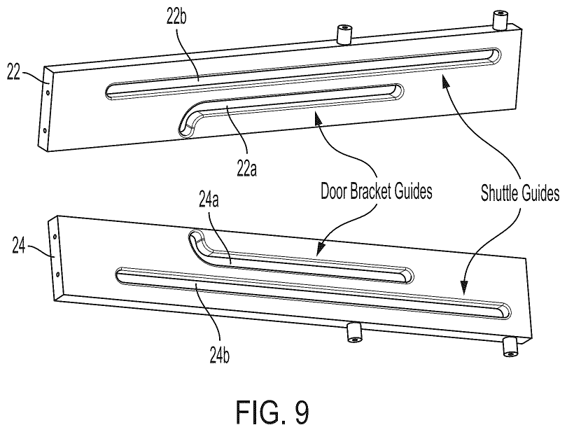

As shown in FIG. 9, the upper shuttle guide slot 22b and the lower shuttle guide slot 24b are straight or linear and thus guide linear movement of the shuttle element 36 (along or behind the vehicle panel) during operation of the actuator 20. The upper cover panel slot 22a and the lower cover panel slot 22b include respective straight or linear portions that are parallel to the respective shuttle guide slots 22b, 24b, and the cover panel slots 22a, 24a include respective curved portions at an end of the cover panel slots 22a, 24a that extend away from the shuttle guide slots 22b, 24b. When the cover panel 14 is in the closed position (FIGS. 2 and 7), the upper pin 30a and the lower pin 30b are in the respective curved portions of the cover panel slots 22a, 24a. As the actuator 20 is operated to move the cover panel 14 from the closed position toward the opened position (FIGS. 3 and 8), the shuttle element 36 moves linearly within the shuttle guide slots 22b, 24b which causes the cover panel bracket 28 and the cover panel 14 to move inward relative to the body panel 10a within the curved portions of the cover panel slots 22a, 24a and then linearly behind the body panel 10a within the straight portions of the cover panel slots 22a, 24a. The links 42 are pivotally attached at the shuttle element 36 and the cover panel bracket 28 to accommodate the lateral movement of the cover panel bracket 28 and cover panel 14 relative to the shuttle element 36 during movement of the cover panel bracket 28 along the curved portions of the cover panel slots 22a, 24a at and near the opened position.

Thus, during operation, the actuator 20 drives the shuttle 36 back and forth via the cam arm 34, which rides in a cam slot 36a on the shuttle 36. The shuttle 36 is constrained to sideways or sliding or linear motion via the upper pins 38a moving within the upper shuttle guides 22b and the lower pins 38b moving within the lower shuttle guides 24b. The slot 32a in the actuator bracket 32 provides an additional constraint for the shuttle 36. Links 42 connect the shuttle 36 to the door or cover panel bracket 28 to cause the door bracket 28 to move generally in a horizontal direction within the cover panel guide slots 22a, 24a. When the cover panel 14 approaches the closed position, the curved portion of the path of the cover panel guide slots 22a, 24a guide the cover panel 14 to move toward and into the opening of the body panel 10a, sealing the opening.

When the cover panel 14 is in the closed position, the cover panel 14 may at least partially compress a sealing element or gasket between a rear or interior side or an edge region of the cover panel 14 and the base portion or side of the vehicle surrounding the charge port 12 and/or the charging connector 16 to protect the connector portion and limit or preclude moisture and contaminants from entering the charge port 12 when the cover panel 14 is closed. For example, the sealing element may be disposed at the interior side of the cover panel 14 or at the base portion and configured to at least partially circumscribe the connector 16 when the cover panel 14 is closed. Optionally, the sealing element or gasket may be disposed at a perimeter edge region of the outer panel 10a defining the aperture for engaging a perimeter edge region of the cover panel 14 when the cover panel 14 is moved into the closed position. In some examples, the sealing element or gasket may be disposed at the perimeter edge region of the cover panel 14 for engaging the perimeter edge region of the outer panel 10a when moved into the closed position. An actuator with high torque output is preferred to actuate a charge port door in the closed position to compress the seal and to open the door against obstructions like ice build-up at the exterior surface of the cover panel. Further, rapid opening of the door is desired to avoid wait times for the user when opening the door to charge the vehicle.

Optionally, the actuator may utilize aspects of the actuators described in U.S. Publication Nos. US-2024-0246485; US-2024-0239267; US-2024-0035318; US-2023-0027125 and/or US-2022-0341226, which are hereby incorporated herein by reference in their entireties.

The charge ports described herein may be illuminated via any suitable means, and may utilize aspects of the charge ports and systems described in U.S. Pat. No. 8,317,376, which is hereby incorporated herein by reference in its entirety. The vehicle may include various indicators to indicate the charge level of the vehicle, such as by utilizing aspects of the systems described in U.S. Pat. No. 10,746,575 and/or U.S. Publication No. US-2021-0129757, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is moved away from the charge port relative to an outer panel of the vehicle to allow access to a charging connector of the charge port;
an actuator that is electrically operable to move the cover panel between the closed position and the opened position;
wherein, when the actuator is electrically operated to move the cover panel between the closed position and the opened position, the actuator imparts translational movement of a translating element relative to the charge port and the outer panel of the vehicle;
wherein the cover panel is pivotally mounted at the translating element, and wherein the cover panel moves between the closed position and the opened position according to translational movement of the translating element relative to the charge port and the outer panel of the vehicle; and
wherein, when the actuator is electrically operated to move the cover panel from the closed position toward the opened position, the translating element translationally moves relative to the charge port and the outer panel of the vehicle and the cover panel (i) moves at least partially away from the outer panel of the vehicle and toward the charge port and (ii) moves at least partially behind the outer panel of the vehicle and away from the charge port.

2. The vehicular charge port closure system of claim 1, wherein, when the actuator is electrically operated to move the cover panel from the opened position toward the closed position, the translating element translationally moves relative to the charge port and the outer panel of the vehicle and the cover panel (i) moves toward the charge port and (ii) moves at least partially toward the outer panel of the vehicle and away from the charge port.

3. The vehicular charge port closure system of claim 1, wherein the cover panel moves along a first path of a track between the closed position and the opened position, and wherein the translating element moves along a second path of the track to move the cover panel between the closed position and the opened position.

4. The vehicular charge port closure system of claim 3, wherein the second path comprises a linear path, and wherein the first path comprises a curved portion and a linear portion, and wherein, as the translating element moves along the linear path to move the cover panel from the closed position toward the opened position, the cover panel moves along the curved portion to move at least partially away from the outer panel of the vehicle and toward the charge port and the cover panel moves along the linear portion to move at least partially behind the outer panel of the vehicle and away from the charge port.

5. The vehicular charge port closure system of claim 4, wherein the linear portion is parallel to and spaced from the linear path.

6. The vehicular charge port closure system of claim 4, wherein the cover panel is pivotally mounted at the translating element via a plurality of links, and wherein the links pivot relative to the translating element and the cover panel to accommodate lateral movement of the cover panel relative to the translating element as the cover panel moves along the curved portion.

7. The vehicular charge port closure system of claim 3, wherein, with the cover panel in the opened position, the charging connector is accessible through an opening in the outer panel of the vehicle, and wherein the track comprises (i) a first portion disposed behind the outer panel of the vehicle at an upper edge region of the opening and (ii) a second portion disposed behind the outer panel of the vehicle and at a lower edge region of the opening.

8. The vehicular charge port closure system of claim 7, wherein the translating element comprises (i) a first pin received at the first portion of the track and (ii) a second pin received at the second portion of the track, and wherein the first pin moves along the first portion of the track and the second pin moves along the second portion of the track to move the cover panel between the closed position and the opened position.

9. The vehicular charge port closure system of claim 3, wherein the cover panel is attached to a bracket, and wherein the bracket comprises a pin that is movably received at the first path of the track.

10. The vehicular charge port closure system of claim 1, wherein, when the actuator is electrically operated to move the cover panel between the closed position and the opened position, the actuator pivots a cam arm in an arcuate path relative to the actuator, and wherein, as the cam arm pivots in the arcuate path, the translating element moves relative to the charge port and the outer panel of the vehicle.

11. The vehicular charge port closure system of claim 10, wherein an end of the cam arm is movably received within a vertically extending slot at the translating element, and wherein a pin at the translating element is movably received within a horizontally extending slot at the actuator, and wherein, as the cam arm pivots in the arcuate path, the end of the cam arm moves within the vertically extending slot and the pin at the translating element moves within the horizontally extending slot to impart horizontal movement of the translating element relative to the actuator.

12. The vehicular charge port closure system of claim 1, wherein the outer panel and the charge port are disposed at a side of the vehicle.

13. The vehicular charge port closure system of claim 1, wherein the vehicle comprises one selected from the group consisting of (i) an electric vehicle and (ii) a plug-in hybrid vehicle.

14. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is moved away from the charge port relative to an outer panel of the vehicle to allow access to a charging connector of the charge port;
an actuator that is electrically operable to move the cover panel between the closed position and the opened position;
wherein, when the actuator is electrically operated to move the cover panel between the closed position and the opened position, the actuator imparts translational movement of a translating element relative to the charge port and the outer panel of the vehicle;
wherein the cover panel is pivotally mounted at the translating element via a plurality of links, and wherein the cover panel moves between the closed position and the opened position according to translational movement of the translating element relative to the charge port and the outer panel of the vehicle;
wherein the cover panel moves along a first path of a track between the closed position and the opened position, and wherein the translating element moves along a second path of the track to move the cover panel between the closed position and the opened position;
wherein, when the actuator is electrically operated to move the cover panel from the closed position toward the opened position, the translating element translationally moves relative to the charge port and the outer panel of the vehicle and the cover panel (i) moves at least partially away from the outer panel of the vehicle and toward the charge port and (ii) moves at least partially behind the outer panel of the vehicle and away from the charge port; and
wherein, when the actuator is electrically operated to move the cover panel from the opened position toward the closed position, the translating element translationally moves relative to the charge port and the outer panel of the vehicle and the cover panel (i) moves toward the charge port and (ii) moves at least partially toward the outer panel of the vehicle and away from the charge port.

15. The vehicular charge port closure system of claim 14, wherein the second path comprises a linear path, and wherein the first path comprises a curved portion and a linear portion, and wherein, as the translating element moves along the linear path to move the cover panel from the closed position toward the opened position, the cover panel moves along the curved portion to move at least partially away from the outer panel of the vehicle and toward the charge port and the cover panel moves along the linear portion to move at least partially behind the outer panel of the vehicle and away from the charge port.

16. The vehicular charge port closure system of claim 15, wherein the links pivot relative to the translating element and the cover panel to accommodate lateral movement of the cover panel relative to the translating element as the cover panel moves along the curved portion.

17. The vehicular charge port closure system of claim 14, wherein, with the cover panel in the opened position, the charging connector is accessible through an opening in the outer panel of the vehicle, and wherein the track comprises (i) a first portion disposed behind the outer panel of the vehicle at an upper edge region of the opening and (ii) a second portion disposed behind the outer panel of the vehicle and at a lower edge region of the opening.

18. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is moved away from the charge port relative to an outer panel of the vehicle to allow access to a charging connector of the charge port;
an actuator that is electrically operable to move the cover panel between the closed position and the opened position;
wherein, when the actuator is electrically operated to move the cover panel between the closed position and the opened position, the actuator imparts translational movement of a translating element relative to the charge port and the outer panel of the vehicle;
wherein, when the actuator is electrically operated to move the cover panel between the closed position and the opened position, the actuator pivots a cam arm in an arcuate path relative to the actuator, and wherein, as the cam arm pivots in the arcuate path, the translating element moves relative to the charge port and the outer panel of the vehicle;
wherein the cover panel is pivotally mounted at the translating element, and wherein the cover panel moves between the closed position and the opened position according to translational movement of the translating element relative to the charge port and the outer panel of the vehicle;
wherein, when the actuator is electrically operated to move the cover panel from the closed position toward the opened position, the translating element translationally moves relative to the charge port and the outer panel of the vehicle and the cover panel (i) moves at least partially away from the outer panel of the vehicle and toward the charge port and (ii) moves at least partially behind the outer panel of the vehicle and away from the charge port; and
wherein, when the actuator is electrically operated to move the cover panel from the opened position toward the closed position, the translating element translationally moves relative to the charge port and the outer panel of the vehicle and the cover panel (i) moves toward the charge port and (ii) moves at least partially toward the outer panel of the vehicle and away from the charge port.

19. The vehicular charge port closure system of claim 18, wherein an end of the cam arm is movably received within a vertically extending slot at the translating element, and wherein a pin at the translating element is movably received within a horizontally extending slot at the actuator, and wherein, as the cam arm pivots in the arcuate path, the end of the cam arm moves within the vertically extending slot and the pin at the translating element moves within the horizontally extending slot to impart horizontal movement of the translating element relative to the actuator.

20. The vehicular charge port closure system of claim 18, wherein the outer panel and the charge port are disposed at a side of the vehicle.
